(19) United States
(12) Patent Application Publication
(10) Pub. No.: US 2014/0053390 A1
(43) Pub. Date: Feb. 27, 2014

(54) ACCESSORY JOINT CONNECTOR

(71) Applicant: Victor Massey, Orting, WA (US)

(72) Inventor: Victor Massey, Orting, WA (US)

(73) Assignee: MILGARD MANUFACTURING INCORPORATED, Tacoma, WA (US)

(21) Appl. No.: 13/595,074

(22) Filed: Aug. 27, 2012

(51) Int. Cl. F16B 33/00; B23P 11/00

(52) U.S. Cl. 29/525.11; 411/337

(57) ABSTRACT

A frame having a front face and a rear face comprises a first lineal, a second lineal, a first lineal joint connector inserted into the first lineal and a second lineal joint connector inserted into the second lineal. A first fastener extends through the first lineal joint connector into the second lineal joint connector. A second fastener extends through the second lineal joint connector into the first lineal joint connector.

### BACKGROUND

Windows and doors are often surrounded by a frame formed from assembled lineals. Assembling the lineals to form the frame can be tedious and time-consuming, often requiring factory assembly or specialized tools for field assembly. Existing frames frequently require lineals with solid filled profiles, increasing the cost and weight of the frame. Such lineals are often connected using angled screws that are screwed into the solid profiles of the lineals. With such screws, it is difficult to adequately tighten the joint between the assembled lineals. Variations in lineal alignment and screw positioning often leads to inconsistent results and splitting of the lineals.

### BRIEF DESCRIPTION OF THE DRAWINGS

FIG. 1 is a fragmentary perspective view of an example lineal connection system in an example frame.

FIG. 2 is a fragmentary perspective view of the example frame of FIG. 1

FIG. 3 is an exploded fragmentary perspective view of an example connector of the connection system and an example lineal of the frame.

FIG. 4 is a fragmentary perspective view of the example connector inserted into the example lineal with the lineal being shown in phantom.

FIG. 5 is a fragmentary perspective view of a miter joint of the example frame without the lineal connection system.

FIG. 6 is a fragmentary perspective view of the example frame with a first connector of the connection system inserted into one of the lineals.

FIG. 7 is a fragmentary perspective view of the frame of FIG. 6 with a second connector the other counterpart lineal and with a first fastener connecting the first and second connectors.

FIG. 8 is a fragmentary perspective view of the frame of FIG. 8 with a second fastener connecting the first and second connectors.

FIG. 9 is a fragmentary perspective view of the frame of FIG. 8 with the lineals shown in phantom.

FIG. 10 is a fragmentary perspective view of a front side of the example frame of FIG. 9.

FIG. 11 is a fragmentary perspective view of a portion of another example frame formed with another example of the connection system of FIG. 1.

FIG. 12 is a fragmentary perspective view of the lineals of the frame of FIG. 11.

FIG. 13 is a side elevational view of the frame and connection system of Figure.

### DETAILED DESCRIPTION OF THE EXAMPLE EMBODIMENTS

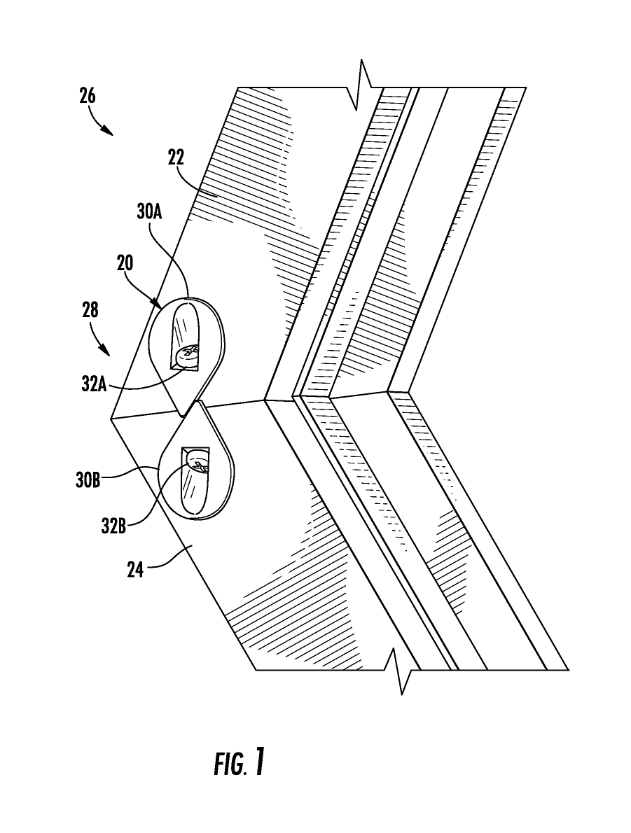

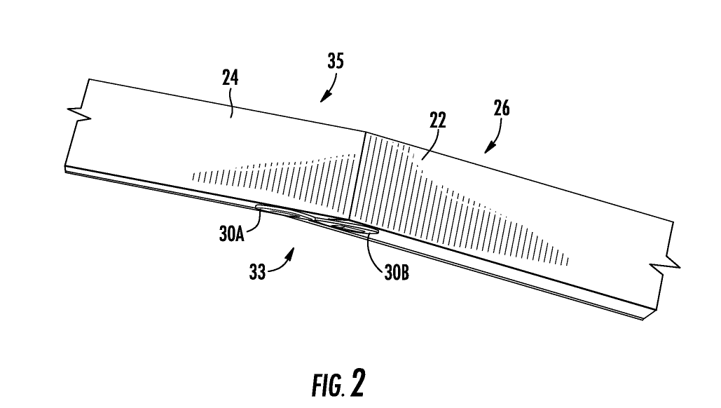

FIGS. 1 and 2 illustrate an example lineal connection system 20. FIGS. 1 and 2 illustrate connection system 20 joining a pair of adjacent frame members or lineals 22 and 24 to form a frame 26. As will be described hereafter, connection system 20 provides a universal joint connection and tightening system that may be used to tighten multiple joint styles, such as butt, scarf, lap, rabbet and miter joints. At the same time, system 20 achieves such joint connections without requiring multiple fixtures, without substantially exposed fasteners, and without precise lineal alignment and fastener positioning demands. As a result, system 20 facilitates a more reliable and simplified connection of joints.

FIGS. 1 and 2 illustrate connection system 20 joining lineals 22, 24 as part of a miter joint 28. As shown by FIGS. 1 and 2, system 20 comprises a pair of cooperating lineal joint connectors 30A, 30B (collectively referred to as connectors 30) and a pair of fasteners 32A, 32B (collectively referred to as fasteners 32). Connectors 30 project into lineals 22, 24 from a backside 33 of frame 26 but do not project through the opposite front side 35 of frame 26. As will be described hereafter, connectors 30 contact and interact with one another to facilitate self alignment. Fasteners 32 interact with both of connectors 30 to secure connectors 30 to one another so as to thereby join lineals 22, 24 to form part of frame 26.

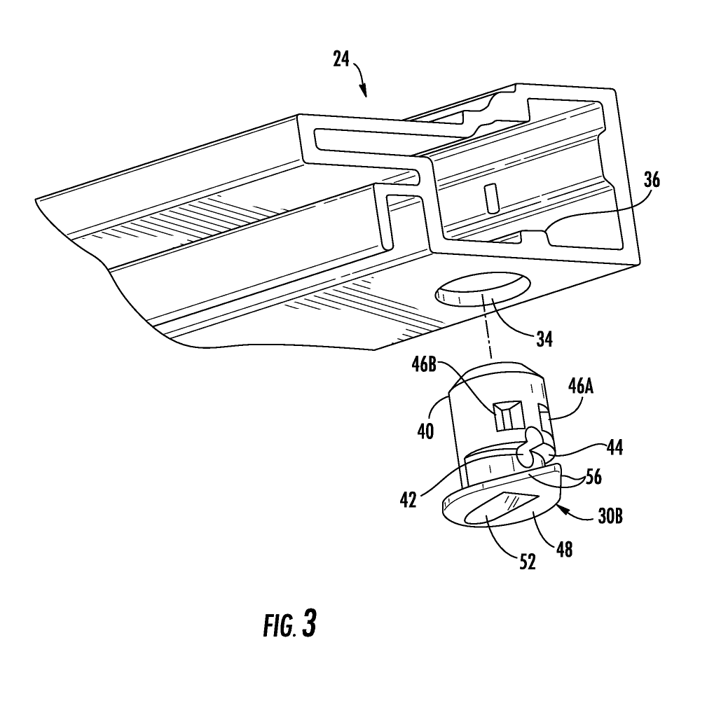

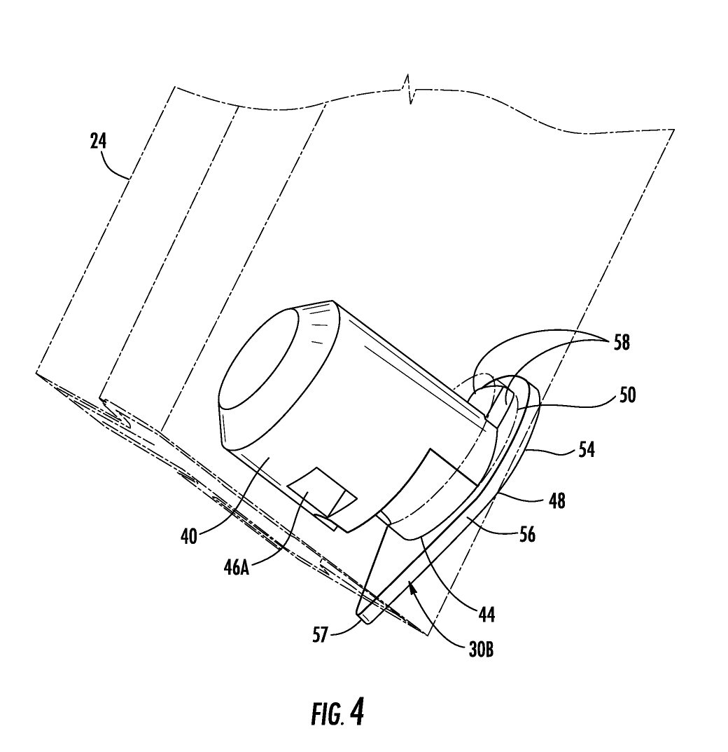

FIGS. 3 and 4 illustrate joint connector 30B and lineal 24 in more detail. FIG. 3 illustrates connector 30B exploded from lineal 24 while FIG. 4 illustrates connector 30B received within lineal 24. As shown by FIG. 3, lineal 24 comprises an elongate, hollow frame member having opening 34 and projection 36. Opening 34 provides a bore or passage through a backside 33 of lineal 24 for the reception of connector 30B. In the example illustrated, opening 34 is circular for receiving a substantially cylindrical portion of connector 30B. In other embodiments, opening 34 may have other shapes depending upon the shape of the portion of connector 30B to be received.

Projection 36 comprises a structure projecting into the hollow interior of lineal 24. Projection 36 facilitates securement of connector 30B within opening 34. In the example illustrated, projection 36 comprises an elongate extruded rib along an inner surface of lineal 24. In other implementations, projection 36 may comprise a single projection. In some implementations, projection 36 may be omitted.

Connector 30B comprises plug portion 40, bore 42, adjustment notch 44, fastener captures 46A, 46B (collectively referred to as captures 46), cap 48, and retaining stop 50. Plug portion 40 comprises that portion of connector 30B that is received within opening 34. In the example illustrated, plug portion 40 is cylindrical. In other implementations, plug portion 40 may have other configurations.

Bore 42 comprises a passage extending through cap 48 and through plug portion 40. Bore 42 receives and guides fastener 32B (shown in FIG. 1) across miter joint 28 and into a fastener capture 46 of connector 30A (shown in FIG. 1). In the example illustrated, bore 42 is angled and includes a countersink portion 52 within cap 48 to receive a head of fastener 32B to conceal fastener 32B to a greater extent and to provide a flat surface along cap 48.

Adjustment notch 44 comprises a cutout, slit, channel or other recess extending into plug portion 40 adjacent to an underside of cap 48. Adjustment notch 44 facilitates adjustable positioning of plug portion 40, bore 42 and fastener captures 46 with respect to opening 34 and with respect to the connector 34A within the other lineal 22 (shown in FIG. 1). Once plug portion 40 has been inserted into opening 34, notch 44 allows connector 30B to be repositioned (slid in a direction parallel to lineal 24) for alignment without otherwise demanding tolerance requirements for the location of opening 34. Such sliding movement of notch 44 locates projection 36 into notch 44 to axially retain connector 44 in place within opening 34. In other implementations, notch 44 and/or projection 36 may be omitted.

Fastener captures 46 comprise structures in plug portion 40 to receive and capture or retain end portions of fastener 32A extending through and from connector 40A in the other lineal 22. In the example illustrated, each fastener capture 46 is configured to receive a threaded end portion of a screw utilized as fastener 32A. In other implementations, fastener captures 46 may have other configurations depending upon characteristics of the fasteners employed by connection system 20.

In the example implementation, each of connectors 30 includes two captures 46 which comprise two detents or tapering channels facing in divergently angled directions. Because each connector 30 includes a plurality of captures 46, each of connectors 30 is interchangeable, usable on either side of a joint, such as the example miter joint 48. In other implementations, each connector 30 may include greater than two captures 46 or may include a single capture 46.

Cap 48 comprises a top of joint connector 30B having an outwardly projecting rim 54 which projects outwardly beyond plug portion 40 and adjustment notch 44. Cap 48 limits or controls the extent to which plug portion 40 extends into opening 34. At the same time, cap 48 interacts with the cap 48 of connector 30A to facilitate alignment of fastener captures 46 of connectors 30. In the example illustrated, each cap 48 has a pair of edges 56 that serve as alignment structures that interact with a corresponding edges 56 of another connector 30, wherein edges 56 of each 48 of the two connectors 30 are symmetrically oriented with respect to bore 42. Because edges 56 are symmetrically oriented with respect to bore 42, each connector 30 is interchangeable with one another, being usable on either of the lineals being connected along the joint. In the example illustrated, each of caps 48 has a tear-drop shape terminating at a point 57 providing the two edges 56 which converge at the point 57. In other implementations, 48 may be triangular or may have other shapes such that edges 56 that are symmetrical with respect to bore 42. In yet other implementations, 48 may have other shapes. For example, in other implementations, caps 48 may have shapes that additionally serve as product identifiers or source identifiers having one or more alphanumeric symbols, product or source identifying symbols, icons, logos and the like.

Retaining stop 50 comprises a projection extending from cap 48 on a side of plug portion 40 opposite to notch 44. Retaining stop 50 interacts with projection 36 to angularly locate or orient connector 30B within opening 34. Retainer stop 50 includes two opposite sides edges 58 which contact projection 56 depending upon the relationship the particular connector 30B has with the other counterpart connector 30A. For example, a left edge of retainer stop 50 may contact projection 36 on one of connectors 30 while the right edge of retainer stop 50 on a counterpart projection 36 contacts projection 36. In other implementations, retainer stop 50 may be omitted.

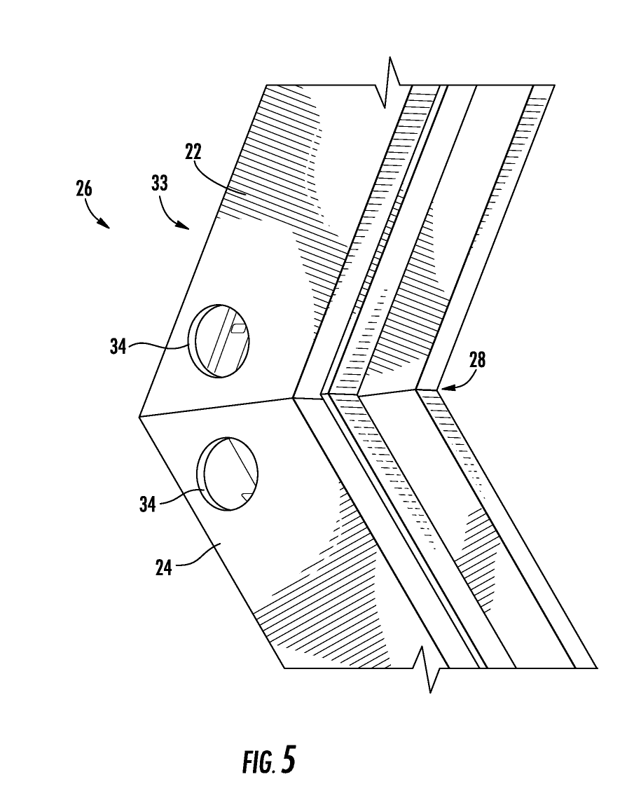

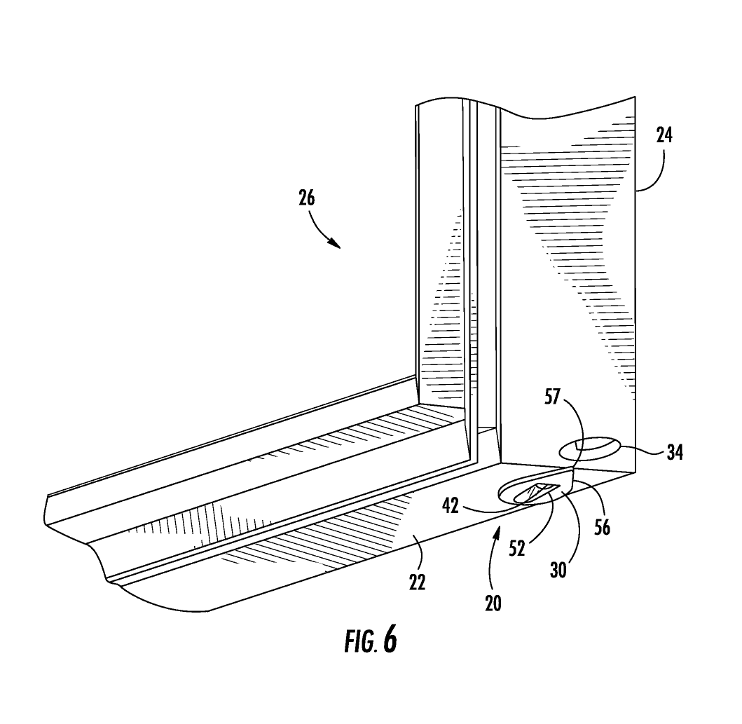

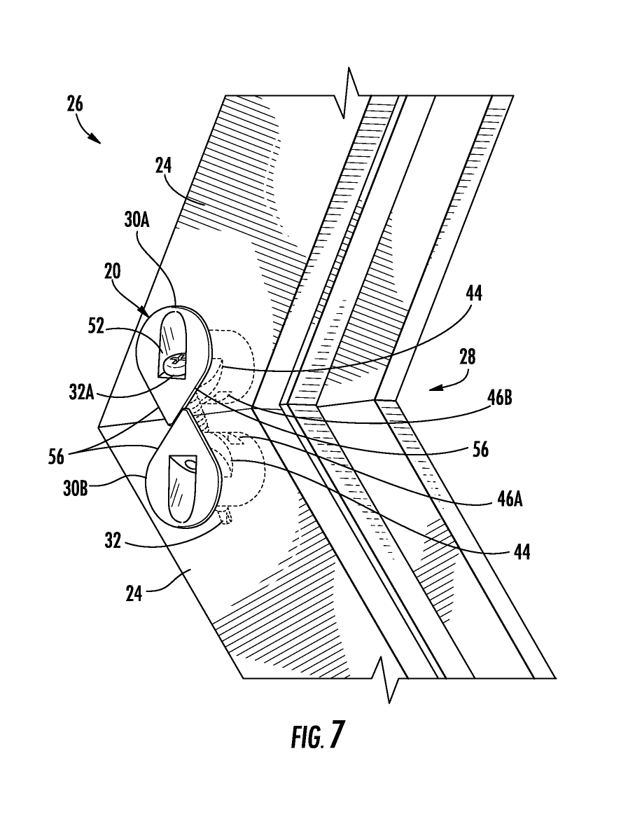

FIGS. 5-10 illustrate the assembly of frame 26 having miter joint 28. As shown by FIG. 5, opening 34 are formed in a backside 33 of each of the lineals 22, 24. As shown by FIG. 6, connectors 30 are inserted into opening 34. As shown by FIG. 7, once both of connectors 30 have been inserted into opening 34, with lineals 22, 24 in abutment with one another along miter joint 28, one or both of connectors 30 may be slid within the openings 30 towards and away from the counterpart connector 30 using the tolerance flexibility provided by notch 44 to a properly positioned such connectors 30 with respect to one another. In the example illustrated, points 57 of connectors 30 are moved towards one another such that an edge 56 of each connector 30 overlaps the tip or point 57 of the other connector 30. Such interaction of edges 56 facilitates alignment of fastener captures 46 with bores 42.

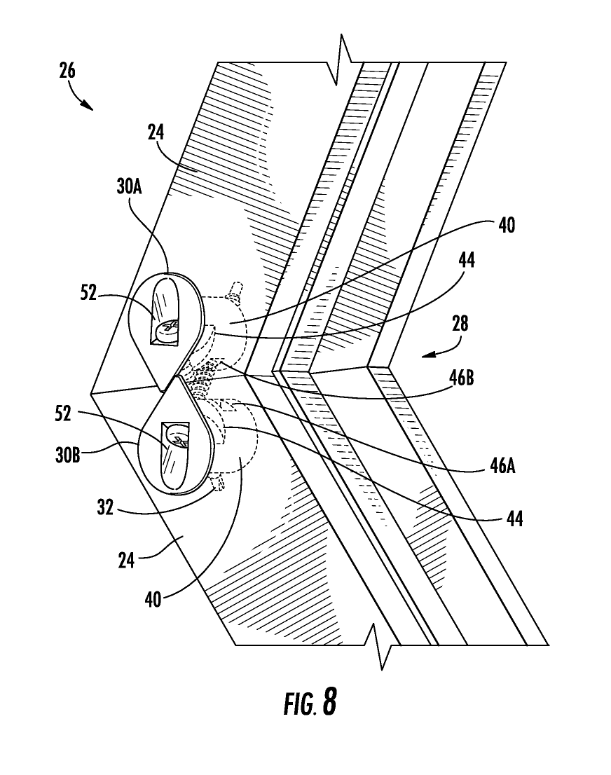

As further shown by FIGS. 7 and 8, once connectors 30 have been properly positioned so as to interact with one another and so as to align fastener captures 46 with bores 42, fasteners 32 are inserted through bores 42 into connection with fastener captures 46. During such insertion, bores 42 guide fasteners 32 into connection with captures 46. In the example illustrated, fasteners 32 comprise screws which are screwed or passed through bores 42 into pilot openings provided by fastener captures 46. Fastener 32 are then screwed into the material of the counterpart connector 30 surrounding the pilot opening or pilot passage of capture 46 which is smaller than the outer diameter of the threads of the fastener 32. As noted above, in other implementations, fastener captures 46 and fasteners 32 may have other configurations. For example, fasteners 32 may alternatively comprise a dart with resiliently flexible unidirectional ribs along shaft which ratchet during insertion of such a fastener into a pilot opening of capture 46.

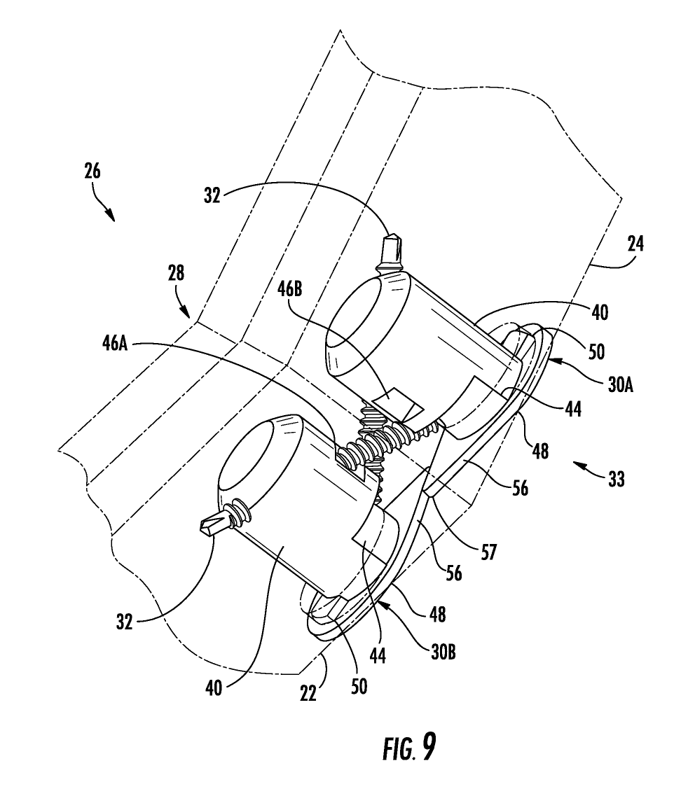

As shown by FIGS. 8 and 9, a fastener 32 is passed through each of connectors 30 and into connection with a corresponding fastener capture 46 of the other counterpart connector 30. Tightening of fasteners 32 resulting connectors 30 being drawn towards one another so as to tighten miter joint 28. Because fasteners 30 to interact with the counterpart connector 30, fastener 30 do not directly grip the lineals to avoid or minimize the potential for splitting. Because fasteners 30 interact with the counterpart connector 30 rather than directly with lineal 22, 24, fastener 30 may be easily removed and replaced upon disassembly and reassembly of frame 26. Because fasteners 30 act against the counterpart connector 30, rather than directly with frame 26, lineals 22, 24 may be more tightly drawn against one another to form a more aesthetically pleasing tight miter joint 28. Because connector 30 have positional flexibility, tolerances for the formation of lineals 22, 24 and openings 34 as well as connectors 30 is greater, reducing manufacturing complexity and cost.

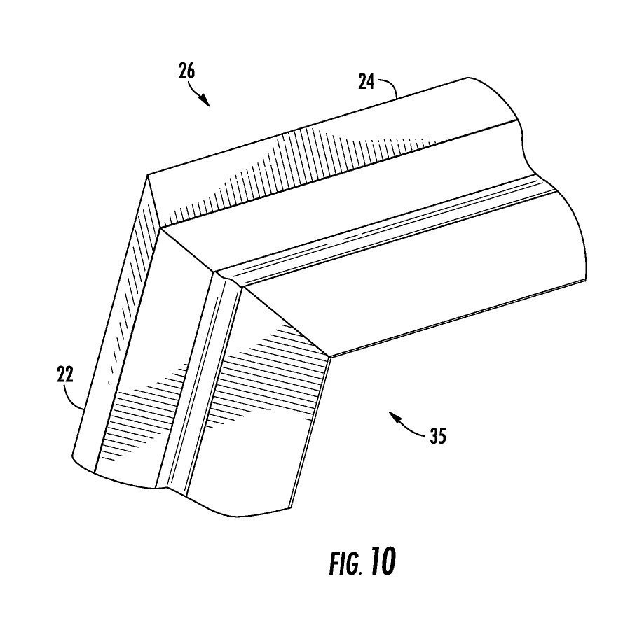

As shown by FIG. 8, fasteners 32 are received within countersinks 52 in caps 48 such that fasteners 32 are discreet. As shown by FIG. 10, fastener 32 as well as connectors 30 are not visible from a front 35 of frame 26. Moreover, because fasteners 32 interact with it counterpart connectors 30 and because the positioning of fasteners 32 is precisely guided by connectors 30, the likelihood that of fastener 32 piercing a visible surface along the front 35 of frame 26 is reduced or eliminated.

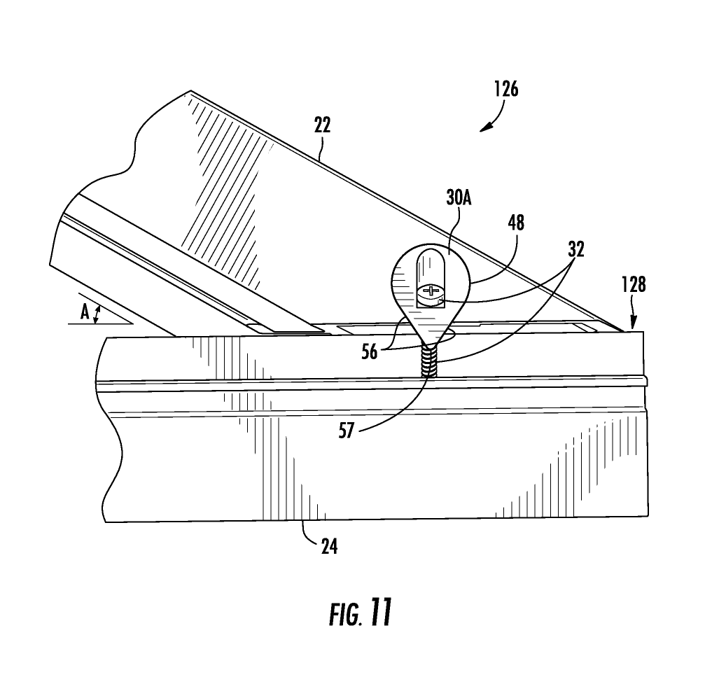

FIGS. 11-13 illustrate connection system 120 joining a pair of adjacent frame members or lineals 22 and 24 to form a frame 126. System 120 achieves such the butt join connection without requiring multiple fixtures, without substantially exposed fasteners, and without precise lineal alignment and fastener positioning demands. As a result, system 120 facilitates a more reliable and simplified connection of joints.

FIGS. 11-13 illustrate connection system 120 joining lineals 22, 24 as part of a butt joint 128. In contrast to connection system 20, connection system 120 employs a single connector 30B and a single fastener 32. As in system 20, in system 120, connector 30 projects into lineal 22, 24 from a backside 33 of frame 126 but does not project through the opposite front side 35 of frame 126. As shown by FIG. 11, connector 30 is received within lineal 22 and guides a fastener 32 into connection with lineal 24. In the example illustrated, connector 30 guides fastener 32 in connection with a pilot opening in lineal 24 to draw lineals 22, 24 together to form the sill nose 128.

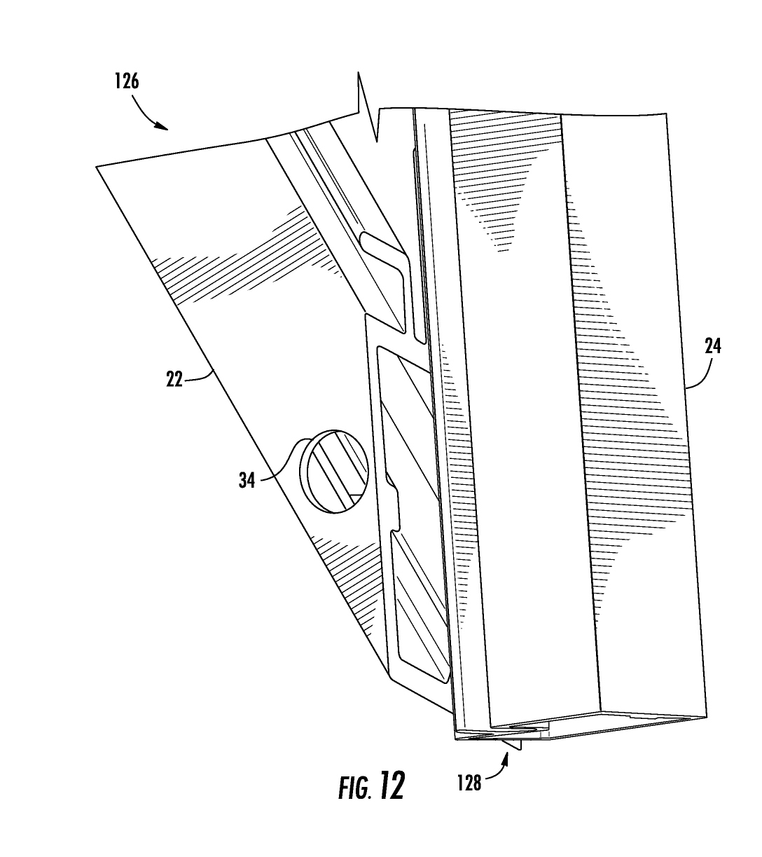

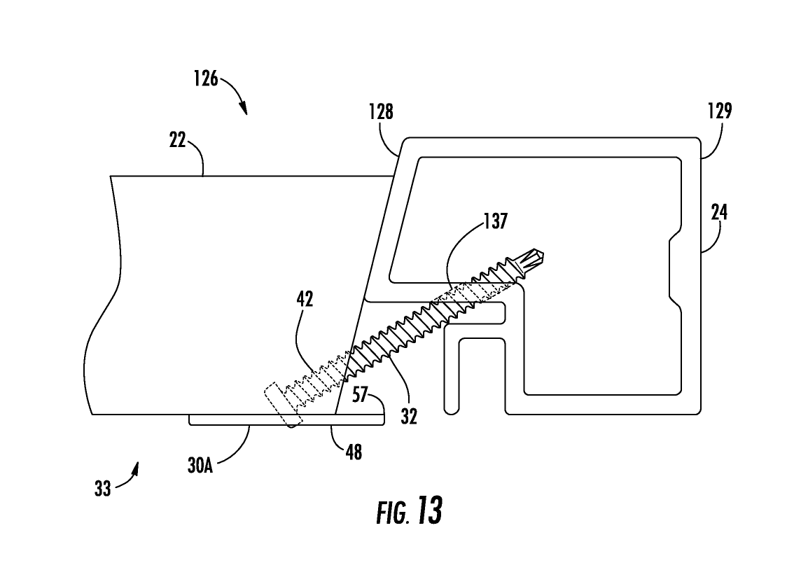

FIG. 12 illustrates lineals 22 and 24 which form butt joint 128, wherein lineal 24 serves as a sill nose 129. In particular, as shown by FIG. 12, lineal 22 is severed for otherwise formed such when lineal 22 is placed in abutment with lineal 24, the angle A (shown in FIG. 11) is produced for the butt joint 128. In addition, opening 34 is formed in lineal 22. As shown by FIGS. 11 and 12, connector 30 is positioned within openings 34 with point 57 overlapping lineal 24. Fastener 32 is inserted through bore 42, wherein bore 42 guides the positioning of fastener 32 into engagement with lineal 24. In one implementation, lineal 24 has a pilot opening 137 (an opening which has a diameter less than the diameter of the threads of the screw) which receives fastener 32. In another implementation, fastener 32 screws into lineal 24. The head of fastener 32 is received within countersink 52. As a result, as shown by FIG. 13, the backside 33 of the formed frame 126 is substantially flat or flush with connector 30 and fastener 32 having minimally projecting beyond the backside of lineals 22, 24.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a lineal joint connector comprising:
a plug portion to be received within a plug opening in a first lineal;
a cap coupled to the plug portion;
an angled bore through the cap and the plug portion to guide a first fastener; and
a fastener capture within the plug portion to capture an end portion of a second fastener extending through a second lineal.

2. The apparatus of claim 1 further comprising a fastener seat within the Adjacent angle board to receive a head of the first fastener.

3. The apparatus of claim 1 further comprising:
a notch within the plug portion on a first side of the connector; and
the retaining bill extending from the cap on a second side of connector opposite the first side.

4. The apparatus of claim 1, wherein the cap comprises an alignment feature to contact a second lineal joint connector identical to the lineal joint connector to align the angled bore of the window joint connector with a fastener capture of the second connector.

5. The apparatus of claim 4, wherein the cap has appointed side providing the alignment feature.

6. The apparatus of claim 5, wherein the lineal joint connector comprises a second fastener capture within the plug portion to capture an end portion of a fastener extending through the second lineal, wherein a point of the pointed side is between the fastener capture and the second fastener capture.

7. The apparatus of claim 5, wherein the lineal joint connector comprises a second fastener capture within the plug portion to capture an end portion of a fastener extending through the second lineal.

8. The apparatus of claim 1 further comprising a frame having a front face in a rear face, the frame comprising:
the first lineal having the plug opening in the rear face;
a second lineal having a second plug opening in the rear face;
the lineal joint connector in the plug opening;
a second lineal joint connector identical to the first lineal joint connector and in the second plug opening;
a first fastener extending through the angled bore of the first lineal joint connector into the fastener capture of the second lineal joint connector; and
a second fastener extending through the angled bore of the second lineal joint connector into the fastener capture of the first lineal joint connector.

9. The apparatus of claim 1, wherein the plug portion comprises a barrel.

10. The apparatus of claim 1 further comprising:
the first lineal having the plug opening in the rear face;
a second lineal; and
a fastener extending through the angled bore of the first lineal joint connector and into the second lineal.

11. A frame having a front face and a rear face, the frame comprising:
a first lineal;
a second lineal;
a first lineal joint connector inserted into the first lineal;
a second lineal joint connector inserted into the second lineal;
a first fastener extending through the first lineal joint connector into the second lineal joint connector; and
a second fastener extending through the second lineal joint connector into the first lineal joint connector.

12. The frame of claim 11, wherein the first lineal joint connector comprises:
a plug portion to be received within a plug opening in the first lineal;
a cap coupled to the plug portion;
an angled bore through the cap and the plug portion to guide the first fastener; and
a fastener capture within the plug portion to capture an end portion of the second fastener extending through the second lineal.

13. The frame of claim 12 further comprising a fastener seat within the cap adjacent the angled bore to receive a head of the first fastener.

14. The frame of claim 12 further comprising:
a notch within the plug portion on a first side of the first lineal joint connector; and
the retaining bill extending from the cap on a second side of first lineal joint connector opposite the first side.

15. The frame of claim 12, wherein the cap comprises an alignment feature to contact the second lineal joint connector identical to the lineal joint connector to align the angled bore of the first lineal joint connector with a fastener capture of the second lineal joint connector.

16. The frame of claim 15, wherein the cap has a pointed side providing the alignment feature.

17. The frame of claim 16, wherein the first lineal joint connector comprises a second fastener capture within the plug portion to capture an end portion of the second fastener extending through the second lineal, wherein a point of the pointed side is between the first fastener capture and the second fastener capture.

18. The frame of claim 12, wherein the lineal joint connector comprises a second fastener capture within the plug portion capturing an end portion of the second fastener extending through the second lineal.

19. The frame of claim 11, wherein the first lineal connector and the second lineal connector each comprise a structure for guiding the first fastener and the second fastener into connection with the other of the first lineal connector and the second lineal connector, respectively.

20. The frame of claim 19, wherein the first lineal connector and the second lineal connector each comprise an alignment feature to contact the other of the first lineal connector and the second lineal joint connector to position the structure for guiding.

21. A method comprising:
inserting a first lineal joint connector into a first lineal;
inserting a second lineal joint connector into a second lineal; and
inserting a first fastener through the first lineal joint connector into the second lineal joint connector; and
inserting a second fastener through the second lineal joint connector into the first lineal joint connector.

22. The method of claim 21, wherein the first lineal joint connector comprises:
a plug portion to be received within a plug opening in the first lineal;
a cap coupled to the plug portion;
an angled bore through the cap and the plug portion to guide the first fastener; and
a fastener capture within the plug portion to capture an end portion of the second fastener extending through the second lineal.
